(19) United States
(12) Patent Application Publication
(10) Pub. No.: US 2024/0217790 A1
(43) Pub. Date: Jul. 4, 2024

(54) Rex Scraper Sled

(71) Applicant: Rex Industrial LLC, Baton Rouge, LA (US)

(72) Inventor: Robert Allan Martin, Baton Rouge, LA (US)

(21) Appl. No.: 18/391,188

(22) Filed: Dec. 20, 2023

Related U.S. Application Data
(60) Provisional application No. 63/477,537, filed on Dec. 28, 2022.

(51) Int. Cl. B66F 7/06; B66F 7/08; B66F 7/28

(52) U.S. Cl. CPC B66F 7/0625; B66F 7/08; B66F 7/28

(57) ABSTRACT

A pig-handling device is disclosed. A pig-handling device comprises a sled including: a container designed to carry one or more pigs, a pig-supporting device connected to the container, a pair of front wheels connected to the pig-supporting device, and a pair of rear wheels connected to the pig-supporting device.

### FIELD OF THE INVENTION

The present invention relates generally to a pipeline pigs preparation device, and more specifically to a pipeline pigs preparation device that can accommodate various pig launcher/receivers designs and site conditions.

### BACKGROUND OF THE INVENTION

A pipeline pig-preparation device that can accommodate various pig launcher/receiver designs and site conditions is in demand.

Contaminants in the fluids transported in fluid-carrying pipelines can collect on the inner surface of the pipeline and may constrict the bore of the conduit. Furthermore, various chemical, mechanical, or electrical reactions within a pipeline may create undesired byproducts, reducing the longevity of the pipeline.

“Pigging” refers to the process of running a cleaning tool (known as a pig or scraper) through industrial pipelines that carry gas and liquids. A pig is introduced to the pipeline via a “launcher” and is retrieved downstream at a “receiver.” Pig launchers/receivers are lateral elements off of the main pipeline and feature doors that allow access for these tools.

The apparatus for cleaning debris buildup in fluid-carrying pipes is typically called a “pig.” A maintenance pig, which can weigh over 1,000 lbs., is awkward to handle in conjunction with launching/receiving; thus, it can be a challenge to align a pig with launchers/receivers of various designs. Therefore, there is a need for the development of a device that facilitates the safe and efficient handling of pigging tools prior to and following the launch process.

The present invention is intended to solve problems associated with conventional pig-management devices and improve on the designs and constructions of these devices.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

A pig-handling device is disclosed. The pig-handling device comprises a sled including: a container designed to carry one or more pigs, a pig-supporting device connected to the container, a pair of front wheels connected to the pig-supporting device, a pair of rear wheels connected to the pig-supporting device, and a plurality of fasteners. In one embodiment, the container includes a half hollow cylinder.

In some embodiments, the pig-supporting device includes a height adjustment component. In some other embodiments, the pig-supporting device includes one or more hydraulic lifting cylinders.

### BRIEF DESCRIPTION OF THE DRAWINGS

FIG. 1 is an illustration of one embodiment of the present invention.

FIG. 2 is an illustration of a top view of the present invention.

FIG. 3 is an illustration of a side view of the present invention.

FIG. 4 is an illustration of a front view of the present invention.

FIG. 5 is an illustration of one embodiment of the present invention with a locking pin.

### DETAIL DESCRIPTIONS OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. Accordingly, the following detailed description does not limit the disclosure. Instead, the proper scope of the disclosure is defined by the claims found herein and/or issuing here from.

The present invention (Rex-Scraper Sled System) is unique in that it is designed to accommodate various launcher/receiver designs and site conditions.

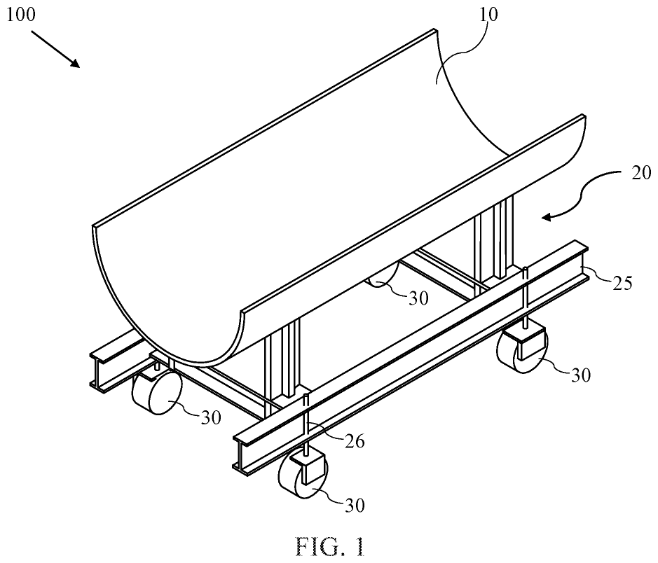

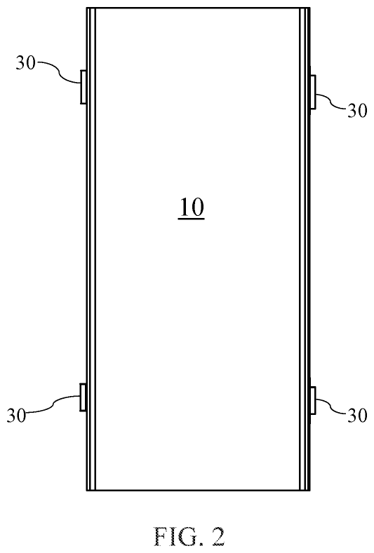

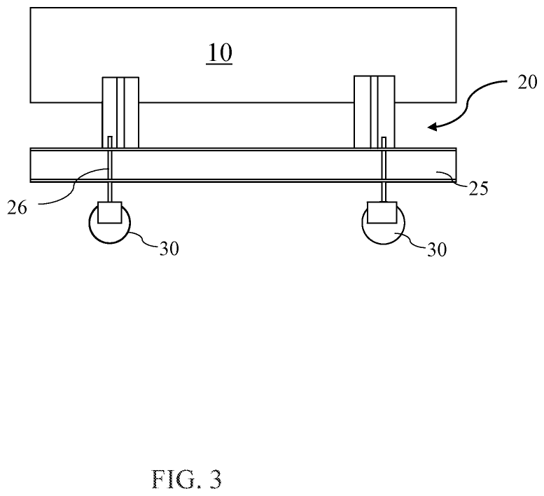

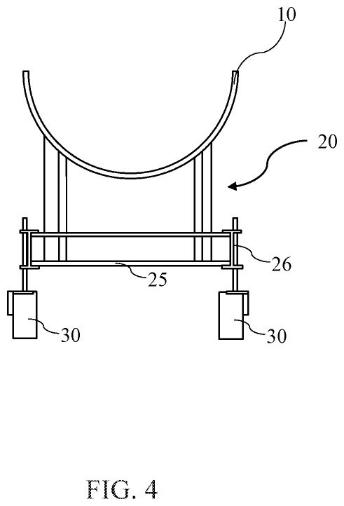

As shown in FIG. 1-FIG. 5, the present invention includes a pig-handling device comprising a sled 100 configured to run on a rail system with position-locking mechanisms, a winch, a cable, a winch stand with a guide, a ramrod, and a plurality of supports.

The present invention provides an adjustable scraper sled 100 guided on a rail system designed to facilitate the safe and efficient handling of the tool prior to and after launch.

The sled 100 is designed to be slidably attached to the rails, allowing the sled 100 to travel between a first and a second position on the rails.

I use with a launcher and/or receiver, the sled 100 can be secured at the first location (location for setting the pig at the launcher, or lifting of pig at receiver) or the second location (at the barrel of launcher and/or receiver). At the launcher the sled 100 can be anchored at the first location to allow for the setting of the pig from a vehicle/trailer. At the launcher, the sled 100 can be secured at the second location to allow a ramrod to push the pig into the barrel by some length using the winch cable attached to the rear of the ramrod. At the receiver, the sled 100 can be secured at the second location to allow the winch to pull the pig out of a barrel onto the sled 100. At the receiver the sled 100 can be anchored at the first location to allow for the lifting of the pig; and then it is placed on a vehicle/trailer.

In another embodiment, the sled 100 can be moved manually on the rails. In yet some other embodiments, the sled 100 can be moved by a powered system that includes a power source and a motor.

In keeping with the teachings of the present invention, the rail system may comprise a plurality of elongated parallel rails.

As shown in FIGS. 1-5, the sled 100 may include a container 10 designed to carry one or more pigs. In some embodiments, the sled 100 may include front and rear wheel pairs 30 operable on the rails to provide freewheeling movement to the sled 100.

In preferred embodiment, the sled 100 includes a pig-supporting device 20 connected to the container 10 and the front and rear wheel pairs 30 can be attached to the container 10. The pig-supporting device 20 may comprise a plurality of panels 25 connected together to form a support structure. The upper portion of the support structure may be attached to the container 10. In some embodiments, the pig-supporting device 20 may include a plurality of locking pins. In addition, in some embodiments, the pig-supporting device 20 may include a winch known in the art stand positioned near one end of the rail system, wherein the winch stand can be connected to a winch that includes a cable wound in the winch.

In some embodiments, the winch stand and/or additional supports support the ramrod, which can be an elongated rod having a suitable length to push the pig into barrel by some length.

In some embodiments, a plurality of anchor bolts 26 can be included in the present invention as fasteners.

In some embodiments, the cable from the winch cable can be connected to one end of the ramrod in a way that when the cable is retracted, the ramrod can be retracted toward the sled 100, pushing pig into barrel by some length.

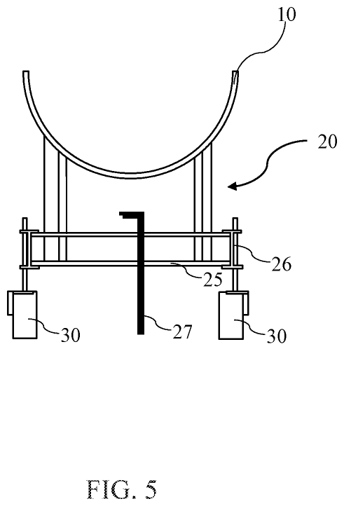

In some embodiments, the pig-supporting device 20 may further include a locking mechanism or one or more locking pins 27 to lock the movement of the sled 100 as shown in FIG. 5.

In some embodiments, the additional support component supporting the ramrod, the winch stand, the sled wheels, and the rail system may include a height adjustment means to adjust the height of the pig-supporting device 20.

In some embodiments, the present invention may include one or more hydraulic lifting cylinders to accommodate the need to reliably and rigidly maintain the pig-supporting device 20 at the desired height. This design will allow the pig-supporting device 20 to be locked in place after being lifted into position by the hydraulic lifting cylinders.

The height adjustment component that can be included in the pig-supporting device 20 can be any adjustment mechanism known in the art and may comprise one or more telescopic beams or may include stationary beam guides and sleeve guides that are slidably attached to the stationary beam guides.

The height adjustment feature may also include a plurality of vertically oriented height adjustment holes extending therethrough. The adjustment holes on the sleeve guide and stationary beam guide can be aligned, and a locking shaft or a pin can be extended therethrough to lock the beam in the desired position to achieve the desired pig-supporting device height. Other locking means can also be utilized instead of shafts or pins. In such embodiments, the sleeve guides of the height adjustment component may comprise square or rectangular cross-sections that receive stationary beam guides with the corresponding square or rectangular cross-sectional shape. The height adjustment holes are constrained to overlay each other at the selected heights. In other embodiments of the present invention, different beam shapes, such as triangular or round beams, can be utilized within the scope of the present disclosure.

Although the invention has been explained in relation to its preferred embodiment, it is to be understood that many other possible modifications and variations can be made without departing from the spirit and scope of the invention.

What is claimed is:

1. A pig-handling device comprising:
a sled including:
a container designed to carry one or more pigs,
a pig-supporting device connected to the container,
a pair of front wheels connected to the pig-supporting device,
a pair of rear wheels connected to the pig-supporting device, and
a plurality of fasteners.

2. The pig-handling device as claimed in claim 1, wherein the pig-supporting device includes a plurality of locking pins.

3. The pig-handling device as claimed in claim 2, wherein the container includes a half hollow cylinder.

4. The pig-handling device as claimed in claim 2, wherein the pig-supporting device includes a height adjustment component.

5. The pig-handling device as claimed in claim 2, wherein the pig-supporting device includes one or more hydraulic lifting cylinders.

6. The pig-handling device as claimed in claim 3, wherein the height adjustment component includes a plurality of vertically oriented height adjustment holes extending therethrough.

7. The pig-handling device as claimed in claim 6, wherein the height adjustment component includes a locking pin.

8. The pig-handling device as claimed in claim 6, wherein the height adjustment component includes rectangular cross-sections.

9. A pig-handling device comprising:
a sled including:
a container having a half hollow cylinder, designed to carry one or more pigs,
a pig-supporting device having one or more hydraulic lifting cylinders, connected to the container,
a pair of front wheels connected to the pig-supporting device,
a pair of rear wheels connected to the pig-supporting device, and
a plurality of fasteners.

10. The pig-handling device as claimed in claim 9, wherein the pig-supporting device includes a plurality of locking pins.

11. The pig-handling device as claimed in claim 9, wherein the pig-supporting device includes a height adjustment component.

12. The pig-handling device as claimed in claim 11, wherein the height adjustment component includes a plurality of vertically oriented height adjustment holes extending therethrough.

13. The pig-handling device as claimed in claim 12, wherein the height adjustment component includes a locking pin.

14. The pig-handling device as claimed in claim 12, wherein the height adjustment component includes rectangular cross-sections.

15. A pig-handling device comprising:
a sled including:
a container having a half hollow cylinder, designed to carry one or more pigs,
a pig-supporting device having a plurality of locking pins, connected to the container,
a pair of front wheels connected to the pig-supporting device,
a pair of rear wheels connected to the pig-supporting device, and
a plurality of fasteners.

16. The pig-handling device as claimed in claim 15, wherein the pig-supporting device includes a height adjustment component.

17. The pig-handling device as claimed in claim 15, wherein the pig-supporting device includes one or more hydraulic lifting cylinders.

18. The pig-handling device as claimed in claim 17, wherein the height adjustment component includes a plurality of vertically oriented height adjustment holes extending therethrough.

19. The pig-handling device as claimed in claim 18, wherein the height adjustment component includes a locking pin.

20. The pig-handling device as claimed in claim 19, wherein the height adjustment component includes rectangular cross-sections.
